(19) United States
(12) Patent Application Publication
(10) Pub. No.: US 2023/0055966 A1
(43) Pub. Date: Feb. 23, 2023

(54) INDOOR AND OUTDOOR SEAMLESS POSITIONING DEVICE FOR DATA SAFETY AND DATA RELIABILITY

(71) Applicant: JastecM CO., LTD., Gyeonggi-do (KR)

(72) Inventor: Yongbeom BAEK, Gyeonggi-do (KR)

(21) Appl. No.: 17/412,379

(22) Filed: Aug. 26, 2021

(30) Foreign Application Priority Data
Aug. 17, 2021 (KR) 10-2021-0108351

(51) Int. Cl. H04W 4/33; H04W 4/029; H04W 4/38; H04W 4/18

(52) U.S. Cl. CPC H04W 4/33; H04W 4/029; H04W 4/38; H04W 4/18

(57) ABSTRACT

An indoor and outdoor seamless positioning device according to an embodiment of the present disclosure includes domains having respective sensors for detecting a target, and a positioning domain receiving sensing data generated by the sensors. The positioning domain may perform data conversion on the sensing data from a first data format having different formats of the sensors to a second data format having a common format of the sensors.

### CROSS REFERENCE TO RELATED APPLICATION

The present application claims priority to Korean Patent Application No. 10-2021-0108351, filed Aug. 17, 2021, the entire contents of which is incorporated herein for all purposes by this reference.

### BACKGROUND

### 1. Field of the Invention

The present disclosure relates to an indoor and outdoor seamless positioning device for data safety and data reliability.

### 2. Description of the Related Art

There has been a very high market demand for a technology for securing indoor positioning data of a moving subject, and for enabling seamless link with outdoor positioning data such as walking or driving.

A conventional positioning calculation method using only simple GPS may have poor precision depending on radio wave reception conditions in a bad radio wave reception situations including tunnels. This error may cause serious accidents, especially for autonomous driving.

Therefore, for seamless and precise positioning calculation, it is necessary to synthesize and combine pieces of information between multiple sensors. To this end, safe and highly reliable exchange of sensor information between different sensors is essential.

The foregoing is intended merely to aid in the understanding of the background of the present disclosure, and is not intended to mean that the present disclosure falls within the purview of the related art that is already known to those skilled in the art.

### SUMMARY

The present disclosure relates to safe and highly reliable exchange of sensor information, in a case of exchanging sensing data between domains for information calculation including precise and seamless positioning calculation.

According to the present disclosure, there is provided an indoor and outdoor seamless positioning device including: domains having respective sensors for detecting a target; and a positioning domain receiving sensing data generated by the sensors, wherein the positioning domain performs data conversion on the sensing data from a first data format having different formats of the sensors to a second data format having a common format of the sensors.

For various information calculations including seamless positioning calculation of a moving subject, the positioning domain PTD can perform sensor fusion or data fusion between sensors.

The positioning domain PTD can switch the data format of the sensing data transmitted from each sensor, from a first data format to a second data format.

By switching the data format from the first data format to the second data format, the positioning domain PTD can reduce the complexity of information calculation including positioning, can reduce the time required for calculation, and can reduce the burden of calculation processing.

The positioning domain PTD can include an authentication step in the process of transmitting and receiving sensing data. The domains exchange their information via the positioning domain PTD, so the domains do not need to provide an authentication step. Therefore, the present disclosure can achieve safe and highly reliable exchange of information via the positioning domain PTD during data exchange.

According to the present disclosure, in addition to simple transmission of response data corresponding to request data, a domain can reserve data transmission in advance, and when data is transmitted to positioning domain PTD, data can be transmitted to multiple domains in a batch.

In such a batch transmission method, when reserved information arrives, data is transmitted to multiple domains in a batch. Therefore, data is effectively transmitted particularly in numerous IoT-related 1-to-N systems.

According to the present disclosure, in complex exchange of sensor information between multiple domains, at least one selected from the group of authentication, translation (decoding), and switching to the second data format can be used through the positioning domain PTD, thus enabling calculation of target information based on safe and reliable exchange of sensor information.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a configuration diagram illustrating a domain and a positioning domain of the present disclosure;

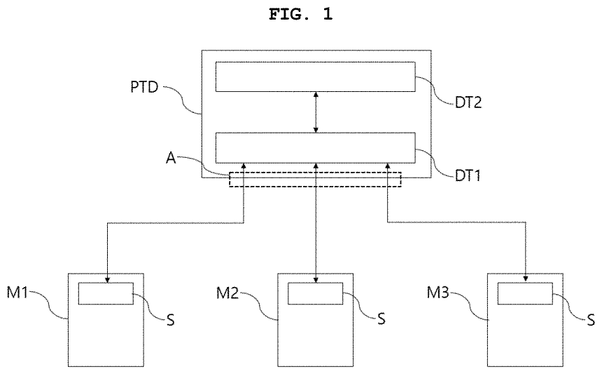

FIG. 2 is an example of FIG. 1;

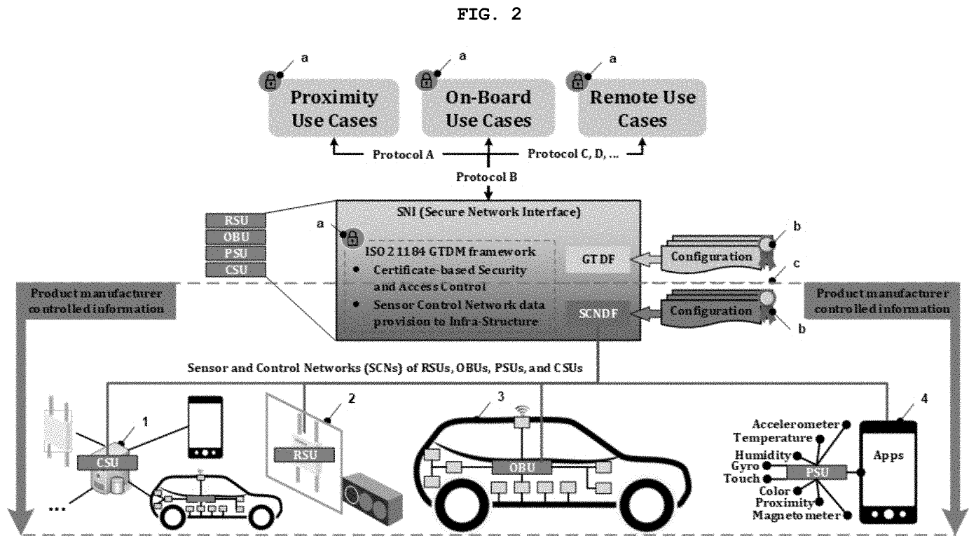

FIG. 3 is a diagram illustrating an example of a data flow of the present disclosure;

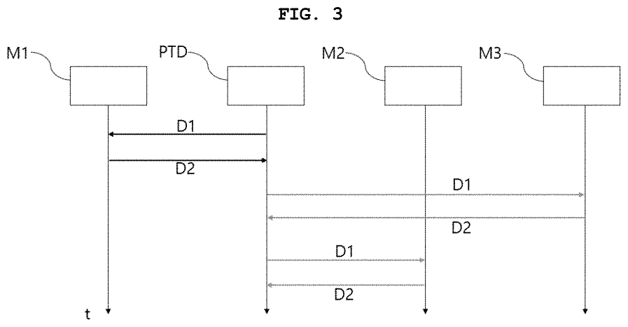

FIG. 4 is a diagram illustrating another example of a data flow of the present disclosure;

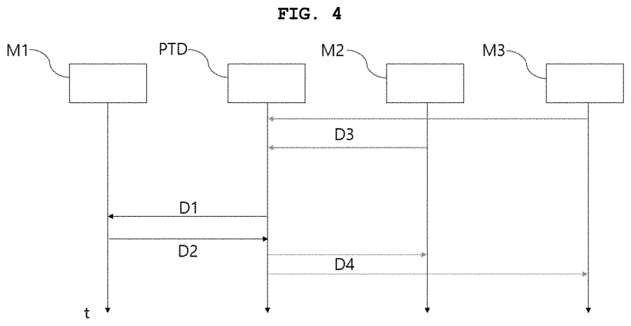

FIG. 5 is a diagram illustrating an example of data configuration and data conversion of the present disclosure; and

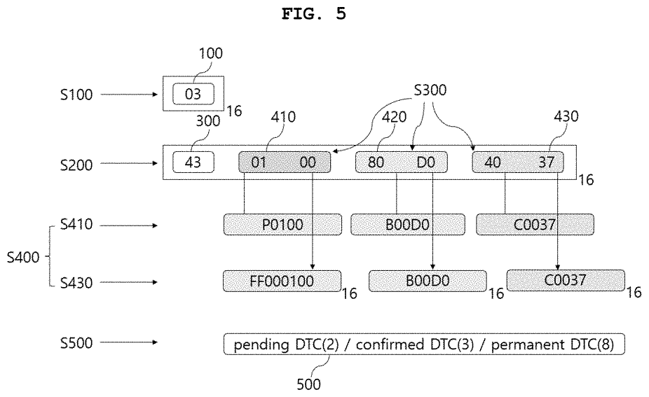

FIG. 6 is a diagram illustrating another example of data configuration and data conversion of the present disclosure.

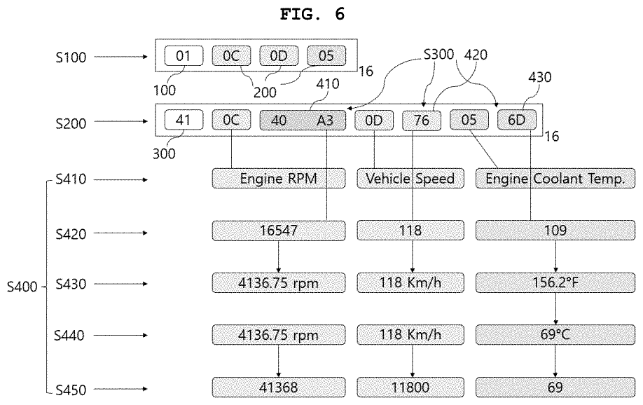

### DETAILED DESCRIPTION

Hereinbelow, exemplary embodiments of the present disclosure will be described in detail with reference to the accompanying drawings. Throughout the drawings, the same reference numerals will refer to the same or like parts.

A moving subject may enter a detection range of a sensor S provided in a domain. The sensor S may generate sensing data required for positioning calculation of the moving subject. The sensing data may be transmitted to a positioning domain PTD that performs sensor fusion on sensing data. That is, for various information calculations including seamless positioning calculation of a moving subject, the positioning domain PTD may perform sensor fusion or data fusion between different sensors.

The positioning domain PTD may switch the data format of the sensing data transmitted from each sensor, from a first data format DT1 to a second data format DT2. Different types of sensing data may have different first data formats DT1s. The different first data formats DT1s may increase the time required for a response to a request for information, and may increase the complexity of information calculation.

Therefore, by switching the data format from the first data format DT1 to the second data format DT2, the positioning domain PTD may reduce the complexity of information calculation including positioning, may reduce the time required for calculation, and may reduce the burden of calculation processing.

For information calculation with respect to the moving subject including positioning calculation of the moving subject, exchange of various types of information may occur between sensors.

A domain may mean a unit or area to which a sensor is attached, wherein the sensor collects data required for positioning calculation of a moving subject. In some cases, a sensor domain may be formed, including a sensor itself in the domain.

The positioning domain PTD may be included in a cloud server or a particular device. In the case in which the positioning domain PTD is included in the particular device, the positioning domain PTD together with a sensor may be provided in the particular device, or the positioning domain PTD may be provided in a particular plug-in external device.

Domains may include a personal domain, an IoT domain, an infrastructure domain, and a positioning domain PTD. There is provided a cloud server that may transmit and receive data to and from a domain in positioning calculation.

Domains may include a first domain M1, a second domain M2, and a third domain M3. The first domain M1, the second domain M2, and the third domain M3 may be one among the personal domain, the IoT domain, the infrastructure domain, the sensor domain, and the positioning domain PTD.

In a case in which the domains makes requests directly to each other and exchange information in response thereto, different sensors may generate sensing data in different data formats, thus being accompanied by a process of interpreting or converting data each time data is received.

For this reason, for example, in a case in which three or more sensors exchange information complexly for data fusion or sensor fusion, direct information exchange between the domains may cause delay in information calculation. Therefore, when such calculation delays are accumulated, fatal results may occur due to errors in information calculation.

For example, in a case of autonomous driving, an accident may occur on the road ahead during autonomous driving, and if accident sensing data generated by the infrastructure near a road arrives at an autonomous vehicle with a delay in time, or is lost, the autonomous vehicle may not be able to avoid an accident with a difference of a few seconds.

The domains of the present disclosure may transmit and receive sensing data to and from each other through the positioning domain PTD. That is, sensing data generated in the first domain M1 may be transmitted to the positioning domain PTD. By a processor including a request, the sensing data may be transmitted from the positioning domain PTD to the second domain M2.

The positioning domain PTD may include an authentication step in the process of transmitting and receiving sensing data. The domains exchange their information via the positioning domain PTD, so the domains do not need to provide an authentication step. Therefore, the present disclosure may achieve safe and highly reliable exchange of information via the positioning domain PTD during data exchange. An authentication section A may be a simplified representation of going through the authentication step when data is transmitted to and received from the positioning domain PTD.

The positioning domain PTD may switch the data format of the sensing data transmitted from each sensor from the first data format DT1 to the second data format DT2. The second data format DT2 may be a data format on which the domains have an agreement in common, or may be a general data format having high readability of sensing data. For example, the second data format DT2 may be the engine RPM of an autonomous vehicle, or Km/h which is the speed of an autonomous vehicle.

The second data format DT2 may include a data format common to sensors in sensor fusion or data fusion. This may reduce calculation delay and calculation burden in sensor fusion or data fusion.

According to the present disclosure, when sensing data is transmitted and received through the positioning domain PTD, the authentication step is performed and the data format of different types of sensing data is switched to the second data format DT2 which is the data format on which an agreement is made in common.

A process of exchanging information between the positioning domain PTD and a domain for information calculation will be described.

The basic unit of information exchange may be transmission of request data D1 and transmission of response data D2 corresponding thereto. A subject transmitting the request data D1 and a subject receiving the request data D1 may be both the positioning domain PTD and a domain. That is, the positioning domain PTD may transmit the request data D1 to a domain and may receive the response data D2 corresponding thereto from the domain. A domain may transmit the request data D1 to the positioning domain PTD and may receive the response data D2 corresponding thereto from the positioning domain PTD.

According to the present disclosure, in addition to simple transmission of the response data D2 corresponding to the request data D1, a domain reserves data transmission in advance, and when data is transmitted to positioning domain PTD, data is transmitted to multiple domains in a batch. This may be called a batch transmission method.

For example, the second domain M2 and the third domain M3 requiring sensing data of the first domain M1 may be provided. The second domain M2 and the third domain M3 may transmit subscription data D3 to the positioning domain PTD. The subscription data D3 is for requesting data, but not for requesting immediate data, and may mean a reservation to receive data when the data of the first domain M1 is transmitted in the future.

When the positioning domain PTD receives the subscription data D3, the positioning domain PTD makes a reservation in advance according to a type of data or time requested with the subscription data D3. The meaning of the time reservation of the subscription data D3 may be to receive information when sensing data is received from the first domain M1 after a particular time or within a particular time period. The meaning of the data type reservation of the subscription data D3 may be to specify a type of partial data for reservation when not the entire sensing data from the first domain M1 but only the partial data of the sensing data of the type is required. This may be called a reservation step.

When the particular time comes, the positioning domain PTD transmits the request data D1 to the first domain M1. The particular time may be a scheduled time caused by the occurrence of a reserved event, or may be a time resulting from the occurrence of a sudden event.

The first domain M1 may transmit the response data D2 corresponding to the request data D1, to the positioning domain PTD.

When the response data D2 is transmitted after the reservation step, the positioning domain PTD transmits batch data D4 in a batch to the domains that have made the reservation at the reservation step.

Accordingly, in the batch transmission method, when reserved information arrives, data is transmitted to multiple domains in a batch. Therefore, data is effectively transmitted particularly in numerous IoT-related 1-to-N systems.

As a first embodiment in which information is exchanged between domains, a case in which the positioning domain PTD makes a request to an IoT domain including an autonomous vehicle for a diagnostic trouble code DTC of the autonomous vehicle will be described.

When the positioning domain PTD makes a request to a domain for data, a request ID block 100 included in the request data D1 is generated. The request ID block 100 may be assigned a value based on the state of the diagnostic trouble code. For example, the request ID block 100 may include at least one selected from the group of a confirmed code, a pending code, and a permanent code.

The confirmed code may indicate that a problem requiring attention to the vehicle has occurred. For example, when a value of a temperature sensor falls to 80° C. or lower, or reaches 120° C. or higher, the confirmed code is generated from the vehicle.

The pending code may indicate a case that is not an emergency inspection situation including displaying an engine checkup, which may be a state in which even though an error has occurred in the past, there is no error now. For example, a normal operation range of the temperature sensor may be from 90° C. to 110° C., but a range from 80° C. to 120° C. may be allowed. Therefore, when the value of the temperature sensor is 85° C. or 115° C., the value is out of the normal operation range, but a pending code rather than the confirmed code is generated.

The permanent code may be a code of a special type that cannot be erased using a scan tool. The permanent code may be automatically deleted when the cause is resolved or when sufficient data is collected during driving under various conditions including idling. However, when an emergency inspection is required for driving of the vehicle, the permanent code may not be arbitrarily deleted until the cause is resolved.

A response ID block 300 included in the response data D2 corresponding to the request data D1 may be generated. The response ID block 300 may be determined by the request ID block 100. In the request ID block 100 and the response ID block 300, each digit may be expressed in hexadecimal and two digits are provided, wherein each digit is a numeral or letter. For example, in the case of the permanent code, if the request ID block 100 corresponding to OA code, the request ID block 100 may be 4A.

A step of generating the request ID block 100 may be called a request step S100, and a step of generating the response ID block 300 may be called a response step S200.

After the response ID block 300 is generated, a data block 400 is generated. The data block 400 may include data detected by a sensor of a domain. When the request data D1 requests the confirmed code of the diagnostic trouble code DTC, the data block 400 displays parts of the vehicle for which the confirmed code is generated.

For example, problems may occur with the vehicle's “A” circuit mass or volume airflow, a left-rear wheel speed sensor, and a seat belt indicator. Regarding the data block 400, a first data block 410, a second data block 420, and a third data block 430 containing respective information may be generated. The data block 400 may follow the response ID block 300, and the first data block 410 to the third data block 430 may be arranged in order. This may be called a data arrangement step S300. Therefore, in this case, the response data D2 may include the response ID block 300 and the data block 400. That is, the data block 400 may include sensing data that indicates actual information on a target by a sensor.

The positioning domain PTD may switch the data format of the response data D2 from the first data format DT1 to the second data format DT2. The switching from the first data format DT1 to the second data format DT2 may be called a data conversion step S400.

The data conversion step S400 may include a parameter translation step S410 or a mapping step S430. At the parameter translation step S410, it is possible to distinguish the vehicle part for which the information in each data block is the diagnostic trouble code. The mapping step S430 may be a step of mapping the data block 400 with a database of the second data format DT2 of the DTC.

The mapping step S430 may be simply adding a predetermined numerical value to the data block 400. For example, the data block 400 may be formed of four letters or numerals, and each digit may be expressed in hexadecimal. In this case, at the mapping step S430, the constant FF00 0000(16) may be added to the value of the data block 400.

A state block 500 making the state of the target visible may be generated according to the type of information. For example, in this case, the confirmed code may be generated for three vehicle parts, and a confirmed DTC(3) or the second data format DT2 for the three vehicle parts may be placed in the state block 500.

As shown in the figure, when all diagnostic trouble code states are requested, the number of confirmed codes and corresponding vehicle parts, the number of pending codes and corresponding vehicle parts, and the number of permanent codes and corresponding vehicle parts may be arranged. This may be called a state step S500.

An example of the entire process of transmitting and receiving information between the positioning domain PTD and a domain will be described.

The second domain M2 may transmit, to the positioning domain PTD, subscription data D3 for requesting information of the first domain M1. The request data D1 may be transmitted from the positioning domain PTD to the first domain M1. The corresponding response data D2 may be transmitted from the first domain M1 to the positioning domain PTD.

The positioning domain PTD may switch the data format of the response data D2 from the first data format DT1 to the second data format DT2. The data of which the data format is switched to the second data format DT2 may be transmitted to the second domain M2.

Another example of the entire process of transmitting and receiving information between the positioning domain PTD and a domain will be described.

The second domain M2 and the third domain M3 may transmit, to the positioning domain PTD, the subscription data D3 for requesting the positioning domain PTD to transmit information of the first domain M1 when the positioning domain PTD receives the information. This may be planned as a schedule in the positioning domain PTD, and this may be called the reservation step.

After the reservation step, when the scheduled time comes or a particular event occurs, the positioning domain PTD transmits the request data D1 to the first domain M1. The corresponding response data D2 may be transmitted from the first domain M1 to the positioning domain PTD. The positioning domain PTD may switch the data format of the response data D2 from the first data format DT1 to the second data format DT2.

The sensing data of which the data format is switched to the second data format DT2 may be transmitted to the second domain M2 and the third domain M3 in a batch. The sensing data may include actually detected information on a target and may be included in a data block. The number of domains to which the batch data D4 is transmitted may be expanded to three or more.

As a second embodiment in which information is exchanged between domains, a case in which the positioning domain PTD makes a request to an IoT domain including an autonomous vehicle for data of the vehicle will be described.

When the positioning domain PTD makes a request to a domain for data, a request ID block 100 included in the request data D1 is generated. In addition, the source ID block 200 for determining the type of information required may be generated. For example, when information on an engine RPM, a vehicle speed, and an engine coolant temperature is required, three source ID blocks 200 are arranged after the request ID block 100 and are transmitted. This may be called the request step S100.

When the response data D2 is transmitted from the domain to the positioning domain PTD, the response ID block 300 is generated. The response ID block 300 may be determined corresponding to the request ID block 100. In the request ID block 100, the source ID block 200, and the response ID block 300, each digit may be expressed in hexadecimal and two digits are provided, wherein each digit is a numeral or letter. This may be called the response step S200.

As many data blocks 400 may be generated as there are source ID blocks 200. In this case, corresponding to three source ID blocks 200, three data blocks 400 may be generated. This may be called the arrangement step S300. At the arrangement step S300, the response ID block 300, the first source ID block 200, the first data block 410, the second source ID block 200, the second data block 420, the third source ID block 200, and the third data block 430 may be arranged in that order.

After the arrangement step S300, the data conversion step S400 may be performed. The data conversion step S400 may include at least one selected from the group of the parameter translation step S410, an extraction step S420, the mapping step S430, a unit conversion step S440, a type conversion step S450, and the state step S500.

The parameter translation step S410 may be a step of distinguishing which vehicle part each source ID block 200 is information about. The extraction step S420 may be a step of extracting raw data from the data blocks 400. At the extraction step S420, conversion from a hexadecimal number to a decimal number may be performed, and in order to secure a sufficient length depending on the type of information, each data block 400 may consist of up to four digits, wherein each digit is expressed in hexadecimal. That is, the data block 400 may consist of two to four digits, wherein each digit is expressed in hexadecimal.

The mapping step S430 may be a step of mapping the data block 400 that has been subjected to the extraction step S420, with the database of the second data format DT2 corresponding to the type of each data block 400. For example, at the mapping step S430, the value of the data block 400 that has been subjected to extraction step S420 may be divided by a particular constant, or may be mapped in the same manner (multiplication of a particular constant), or a particular constant may be added to or subtracted from the value. Then, a unit corresponding to each data block type is placed.

For example, when the data block 400 indicating an engine coolant temperature has a value of 6D, 6D is changed to 109 at the extraction step S420 and 109 is changed to 156.2° F. at the mapping step S430. The unit conversion step S440 may be a step of performing unit conversion on the value of the data block 400 that has been subjected to the mapping step S430 when necessary. For example, 156.2° F. may be changed to 69° C. The above example is for convenience of description. In some cases, when not necessary, 69° C. may be acquired at the mapping step S430 and the unit conversion step S440 may be not required.

The type conversion step S450 may be a numerical-value adjustment step for the second data format DT2, including removing the unit of the value of the data block 400 that has been subjected to the mapping step S430 or the unit conversion step S440, truncating values below the decimal point, rounding up, or rounding down.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. An indoor and outdoor seamless positioning device, comprising:
domains having respective sensors for detecting a target; and
a positioning domain receiving sensing data generated by the sensors,
wherein the positioning domain performs data conversion on the sensing data from a first data format having different formats of the sensors to a second data format having a common format of the sensors.

2. The device of claim 1, wherein the domains include a first domain and a second domain; and
when there is a request for information of the first domain from the second domain, the positioning domain performs the data conversion on the sensing data received from the first domain and transmits a resulting data to the second domain.

3. The device of claim 1, wherein the domains include a first domain, a second domain, and a third domain;
when information of the first domain is required, the second domain and the third domain transmit subscription data to the positioning domain;
when the positioning domain receives the subscription data, the positioning domain sets a transmission reservation including a reservation time or a reservation type;
the reservation time is a time requested by the second domain and the third domain or an emergency event occurrence time, and the reservation type is a particular data type of the first domain that the second domain and the third domain require;
the positioning domain transmits request data to the first domain at the reservation time;
the first domain transmits response data corresponding to the request data to the positioning domain; and
when the response data is transmitted, the positioning domain performs the data conversion and transmits batch data to the second domain and the third domain in a batch, the batch data resulting from the data conversion of the sensing data.

4. The device of claim 1, wherein when one of the domains requires the sensing data of another of the domains for information calculation on the target, the sensing data is exchanged between the two domains through the positioning domain;
the positioning domain is provided with an authentication section; and
the authentication section is for authenticating a protocol of the domain that transmits the sensing data or of the domain that receives the sensing data when the sensing data is transmitted or received.

5. The device of claim 1, wherein the positioning domain transmits request data for requesting information on the target to the domains, and the domains transmit response data corresponding to the request data to the positioning domain;
a request ID block included in the request data is generated and a response ID block included in the response data is generated; and
the request ID block is determined according to the requested information on the target and the response ID block is determined by the request ID block.

6. The device of claim 1, wherein the positioning domain transmits request data for requesting information on the target to the domains, and the domains transmit response data corresponding to the request data to the positioning domain;
a request ID block included in the request data is generated and a response ID block included in the response data is generated; and
after the response ID block is generated, a data block is generated;
the data block contains information on the sensing data; and
in the request data, the response ID block and the data block are included, and the response ID block and the data block are arranged in that order.

7. The device of claim 1, wherein the positioning domain receives response data from the domains;
the response data includes a data block containing information on the sensing data;
the data conversion includes mapping for the data block, and parameter translation; and
the mapping is for mapping the data block with a database of the second data format, and the parameter translation is for distinguishing which part of the target the information contained in the data block is about.

8. The device of claim 1, wherein the positioning domain transmits request data for requesting information on the target to the domains;
the domains transmit response data corresponding to the request data to the positioning domain;
the response data includes a data block containing information on the sensing data; and
a state block enabling the information contained in the data block to be wholly understood is generated.

9. The device of claim 1, wherein the positioning domain receives response data from the domains;
the response data includes a data block containing information on the sensing data;
the data conversion includes mapping and parameter translation, the mapping being for mapping the data block with a database of the second data format, and the parameter translation being for distinguishing which part of the target the information contained in the data block is about;
the data conversion includes extraction of raw data that is a numerical value of the sensing data, from the data block; and
regarding the data conversion, the parameter translation, the extraction, and the mapping are performed in that order.

10. The device of claim 1, wherein the data conversion includes at least one selected from the group of parameter translation, extraction, mapping, unit conversion, and type conversion;
the parameter translation is for distinguishing which part of the target information contained in a data block is about;
the extraction is for extracting raw data that is a numerical value of the sensing data, from the data block;
the mapping is for mapping the data block with a database of the second data format;
the unit conversion is for converting a unit of the data block that has been subjected to the mapping; and
the type conversion is for adjusting a numerical value in the second data format, including removing the unit, truncating values below a decimal point, rounding up, or rounding down, with respect to the data block that has been subjected to the mapping or the unit conversion.
